(19) United States
(12) Patent Application Publication
(10) Pub. No.: US 2007/0210496 A1
(43) Pub. Date: Sep. 13, 2007

(54) Suspension system for motor vehicles

(75) Inventor: Hubert Beck, Eitorf (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/711,571

(22) Filed: Feb. 27, 2007

(30) Foreign Application Priority Data
Mar. 11, 2006 (DE) 102006011397.7-12

(51) Int. Cl. F16M 7/00; F16M 1/00

(52) U.S. Cl. 267/140.4; 267/140.2

(57) ABSTRACT

A piston-cylinder unit includes a working cylinder, a damping piston mounted for movement in the cylinder, and a piston rod connected to the piston. An outer tube surrounding the working cylinder defines a compensating space, and a piston rod guide fitted to the working cylinder and the outer tube closes off an end of the compensating space, the piston rod guide having a bore communicating with the compensating space. An envelope body of variable shape, located in the compensating space, is filled with gas through a connecting element having a cylindrical portion fitted in the bore. The connecting element also has a lobe which is received through an elongate aperture in a retaining plate fitted over the bore when the connecting element is in a selected orientation, the lobe being axially retained under the plate by rotating the connecting element from the selected orientation.

### BACKGROUND OF THE INVENTION

1. Field of the Invention

The invention pertains to a suspension system for motor vehicles, having at least one piston-cylinder unit with a working cylinder, a piston rod, and a damping piston equipped with damping valves, wherein a closed envelope body of variable shape is provided in a compensating space, the walls of which include a gas-tight barrier layer and which has a connecting element mounted in the piston rod guide.

2. Description of the Related Art

Level-control elements (U.S. Pat. No. 6,648,309) and shock absorbers (U.S. Pat. No. 6,116,585) are already known in which the piston rod volume compensation, i.e. the compensation for the volume of damping fluid displaced by the piston rod, is performed by an envelope body filled with gas.

U.S. Pat. No. 6,648,309 describes a method for filling the envelope body with gas, but it does not say how the body can be reliably and effectively attached to the piston rod guide. U.S. Pat. No. 6,116,585 describes an envelope body but does not discuss in detail how it is attached.

A suspension system for motor vehicles is also known (U.S. Pat. No. 7,097,015) in which an envelope body is mounted in the piston rod guide by means of a snap-in connection. This method of attachment is characterized by fast and reliable installation, but there is a problem with recovering the individual parts if, after installation or partial installation of the unit consisting of the piston rod guide and the envelope body, leaks are detected during a subsequent leak test. If leaks are detected, the snap-in connection does not allow the envelope body to be removed from the piston rod guide without destroying it.

### SUMMARY OF THE INVENTION

An object of the invention is to provide a suspension system for motor vehicles in which a closed envelope body of variable shape is attached to the suspension system in such a way that the envelope body is mounted permanently and in a leak-proof manner in the compensating space. A flow connection is provided for filling the envelope body with gas from the outside, where the connecting element connected to the envelope body can be easily produced and can be installed in a gas-tight manner in the piston rod guide.

To accomplish this object, the connecting element has at least one lobe, which fits through a corresponding aperture in a retaining plate, where the retaining plate permanently covers the bore in the piston rod guide. The connecting element is retained by rotating so that the lobe is under the plate adjacent to the aperture.

The advantage of this solution is that the connecting element together with the envelope body can be installed by means of a positive connection, and, if a leak is detected during the testing of the components, the connecting element can be easily detached and replaced. The connecting element has a cylindrical sealing area which, during the production process, can be removed axially from the mold and thus obtained without mold-removal burrs. The absence of mold-removal burrs offers the advantage that the sealing ring will not allow any leaks to occur during the operation of the suspension system.

The connecting element is preferably designed to be produced as a molded part and has, in its cylindrical sealing area, a surface which is free of mold-removal burrs.

According to another essential feature, the retaining plate is fixed to the piston rod guide by a process of peening.

According to a favorable embodiment, the external periphery of the retaining plate deviates at least partially from a circular shape. To simplify centering during installation, the retaining plate has a keying device.

According to another embodiment, the retaining plate has a notch to prevent it from being twisted out of position. Some of the material displaced during the peening operation flows into this notch.

According to an elaboration of the invention, the retaining plate is mounted in a recess in the piston rod guide. The shape of the recess corresponds to that of the retaining plate.

According to another embodiment, the connecting element carries a sealing ring, which is located between the piston rod guide and a support ring, which is mounted on the connecting element. It is advantageous here that the support ring is held on the connecting element in such a way that that it retains a certain freedom of axial movement and separates the damping medium from the gas, where the sealing ring is supported briefly on the support ring only while the envelope is being filled with gas.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial cross section of a suspension system for motor vehicles;

FIG. 2 shows an enlarged view of a cross section of an envelope body with its connecting element in isolation; and

FIGS. 3-11 show cross sections, front views, and perspective views of details of the connecting element.

### DETAILED DESCRIPTION OF THE PRESENTLY PREFERRED EMBODIMENTS

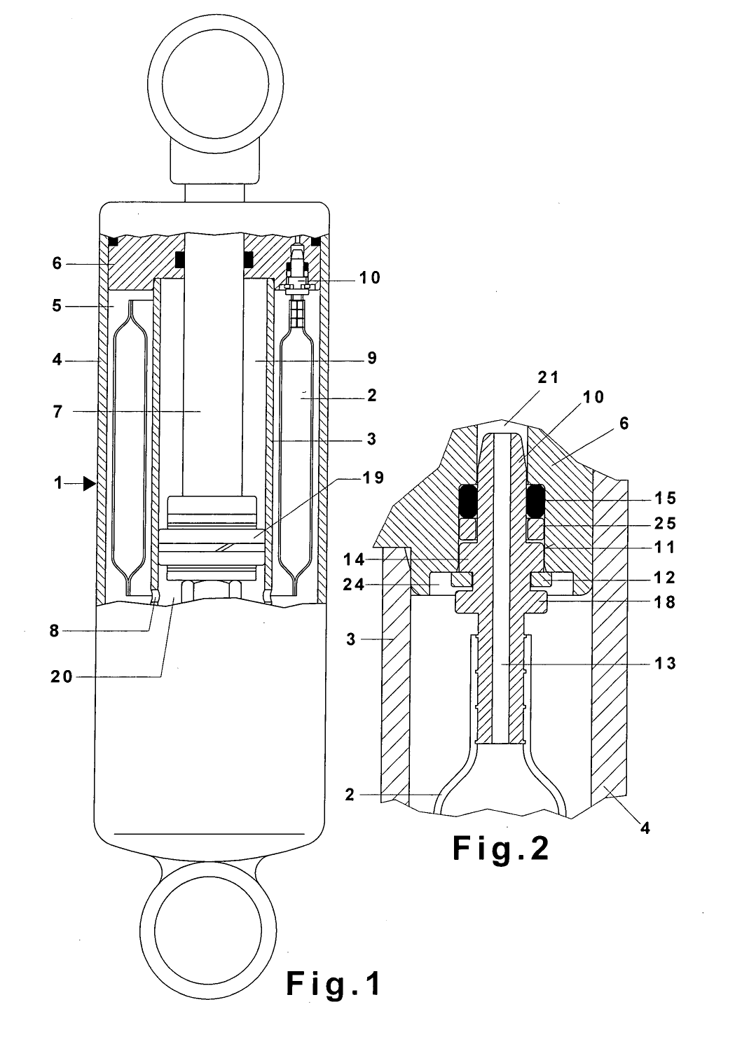

FIG. 1 shows a suspension system 1, which can be a self-pumping hydropneumatic spring strut or a vibration damper, consisting of a working cylinder 3, in which a piston 19 is installed, where the upper working space 9 is formed between the piston 19 and the piston rod guide 6. An outer tube 4, which forms the compensating space 5, is provided coaxially around the working cylinder 3.

The piston rod 7 guiding the piston 19 extends out through the piston rod guide 6 to the atmosphere. The connecting element 10 of the envelope body 2 is also mounted in this piston rod guide 6.

The lower working space 20 is connected to the compensating space 5 by the opening 8.

FIG. 2 shows a detailed view of the working cylinder 3, surrounded by the outer tube 4, and of the piston rod guide 6 with its bore 11, mounted between the working cylinder 3 and the outer tube 4. The connecting element 10 is mounted in this bore 11.

The piston rod guide 6 is provided with a recess 24, in which the retaining plate 12 is peened in place, i.e. the material of the guide is deformed so that the retaining plate 12 is permanently attached to the piston rod guide 6. The connecting element 10 is provided with an opening 13, which starts from the interior of the envelope body 2 and extends all the way to the flow connection 21. The connecting element 10 is introduced into the bore 11 until the lobes 14, which function as a bayonet fastener, are on the far side of the retaining plate 12. The connecting element can then be fixed in place in the piston rod guide 6 by turning it 90°, for example.

The sealing ring 15 for sealing off the connecting element 10 is also mounted in the bore 11. The radial pretension of the ring produces the necessary sealing action. Similarly, a support ring 25 is mounted in the bore 11; this ring ensures that the entire surface area of the sealing ring 15 is supported while the envelope is being filled with gas.

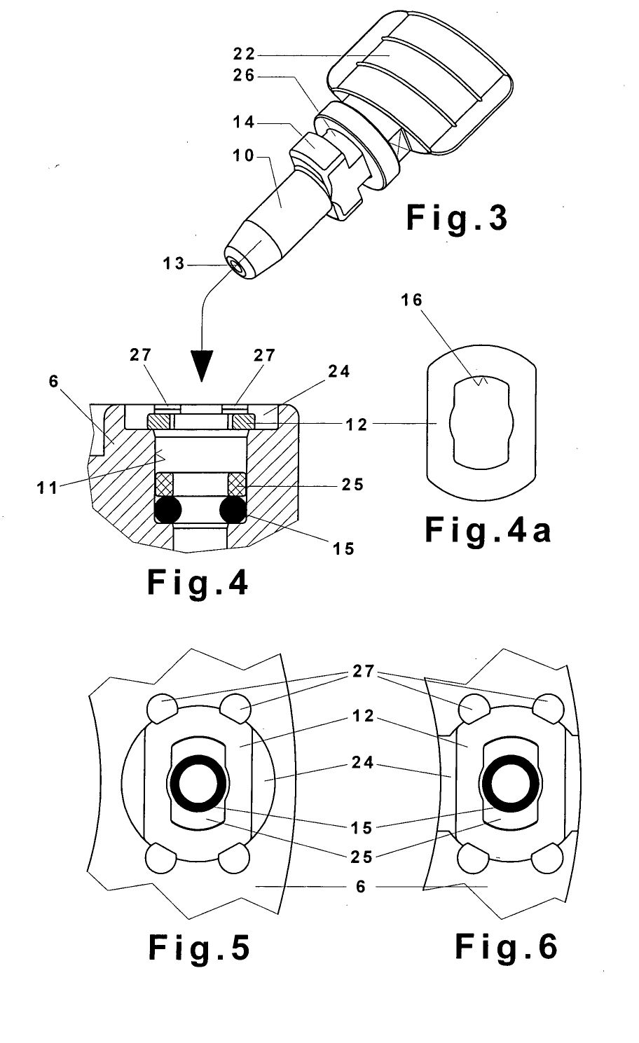

FIG. 3 shows a perspective view of a connecting element 10 in isolation, through which the opening 13 extends in the axial direction. The two diametrically opposing lobes 14 are used to hold the connecting element in place against the retaining plate 12. By turning these lobes by approximately 90° during the assembly process, the desired connection is thus established with the piston rod guide 6. That is, the lobes 14 are first able to fit through the elongate aperture 16 in the retaining plate 12 and can then be turned 90°, as can be seen in FIG. 4 as an isolated detail. The retaining plate 12 thus engages in the channels 26 in the connecting element 10. The fastening element 22 is used to hold the envelope body 2, as can be seen in FIG. 1.

It can also be derived from FIG. 4 that the bore 11 is located in the area of the piston rod guide 6 in which the sealing ring 15 is mounted. The support ring 25 rests loosely on the sealing ring 15. The retaining plate 12 is held in the recess 24 of the piston rod guide 6 by the peened areas 27.

FIG. 4a shows a retaining plate 12 in isolation. The elongate aperture 16 allows the lobes 14 to pass through. Upon subsequent rotation by 90°, the bayonet fastening effect is obtained.

FIGS. 5 and 6 show top views of the retaining plate 12, which has been permanently connected to the piston rod guide 6 by the peened areas 27. The sealing ring 15 and the support ring 25 can also be seen in these top views.

FIG. 6 shows in particular that the outer contour of the retaining plate 12 can be adapted as needed when the amount of space available for installation is very limited. If the available space is very generous, as shown in FIG. 5, however, the retaining plate 12 could also be a disk, in contrast to what is shown the diagram, and thus conform to the shape of the recess 24.

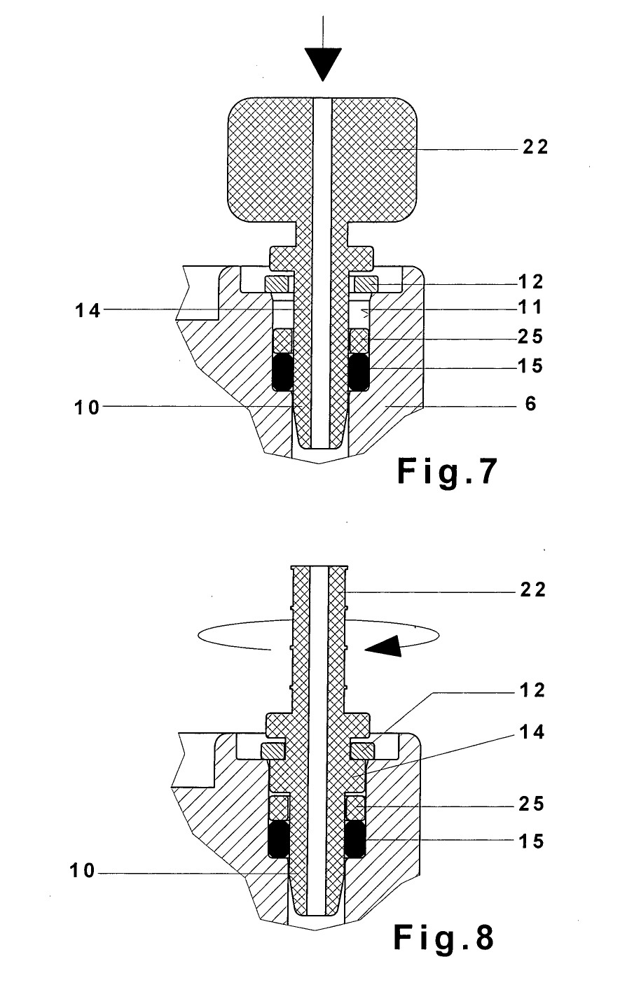

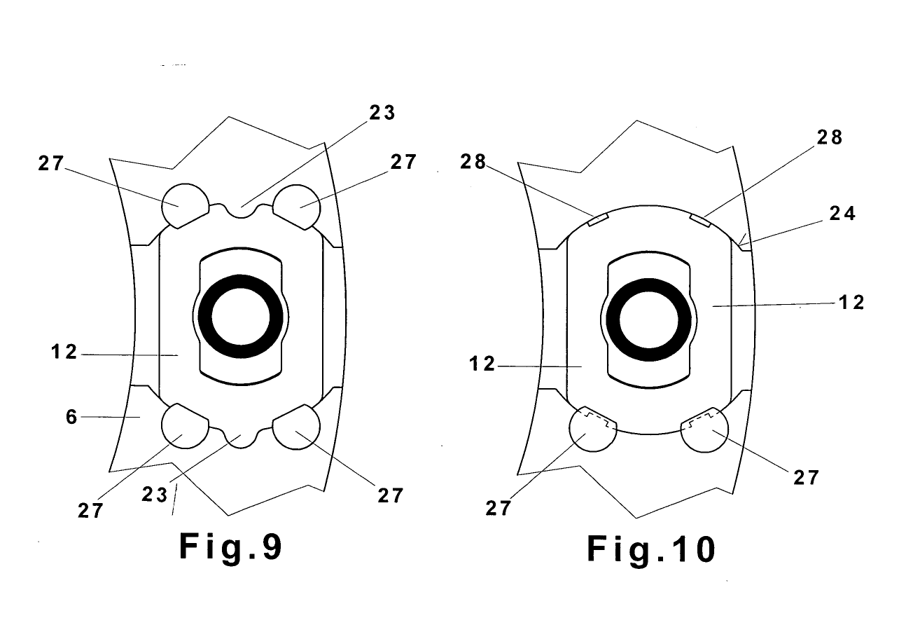

FIG. 7 shows a piston rod guide 6, where the sealing ring 15 and the support ring 25 for the seal are mounted in the bore 11. The retaining plate 12 is permanently connected to the piston rod guide 6 by peening. The contours of the lobes 14 (not visible here) of the connecting element 10 have been appropriately oriented, and then the connecting element has been introduced axially through the retaining plate 12. The fastening element 22 is then, as shown in FIG. 8, rotated 90°, so that the lobes 14 are axially secured against the retaining plate 12 and the connecting element 10 is axially secured. FIG. 9 shows detailed views of the piston rod guide 6, where the retaining plate 12 is connected to the piston rod guide 6 by the peened areas 27. According to the upper part of FIG. 9, a centering aid 23 is provided in the piston rod guide 6; this centering aid has a projection, which extends into a corresponding recess in the retaining plate 12. In contrast, the lower part of FIG. 9 shows a retaining plate 12 with a centering aid 23 in the form of a projection, which extends into a recess in the piston rod guide 6.

The upper part of FIG. 10 shows the retaining plate 12 with a notch 28 in at least one location on the periphery. The retaining plate 12 can be positioned by means of a contour pin and centered in the recess 24.

The lower part of FIG. 10 shows the retaining plate 12 after the production of the peened areas 27. Because some of the material displaced from the piston rod guide 6 flows into the notch 28 in the retaining plate 12, a positive connection is produced, which also has the effect of preventing the attached parts from rotating. The advantage of this design is therefore that, in contrast to FIGS. 9a and 9b, the recess 24 can also be easily produced by machining.

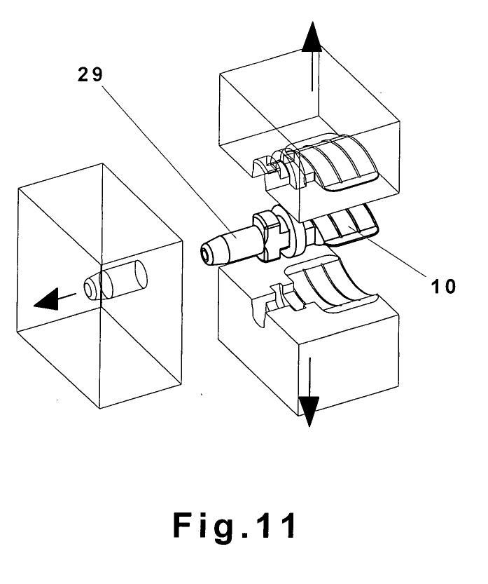

FIG. 11 shows the connecting element 10 as an injection-molded part after it has been removed from the mold. So that the cylindrical sealing area 29 will have a smooth surface free of mold-removal burrs and thus function reliably, this area is preferably unmolded axially, whereas the area with the undercut must obviously be unmolded radially.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A suspension system for motor vehicles, comprising:
a piston-cylinder unit comprising a working cylinder, a damping piston mounted for movement in said cylinder, and a piston rod connected to the piston;
an outer tube surrounding said working cylinder and defining a compensating space between said outer tube and said working cylinder;
a piston rod guide fitted to said working cylinder and said tube to close off an end of said compensating space, said piston rod passing through said piston rod guide, said piston rod guide having a bore communicating with said compensating space;
an envelope body of variable shape in said compensating space, said envelope body comprising a gas-tight barrier layer;
a retaining plate fitted over said bore in said piston rod guide, said retaining plate having an elongate aperture; and
a connecting element having a cylindrical portion fitted in said bore and a lobe which is received through said elongate aperture in a selected orientation, said lobe being axially retained under said plate by rotating said connecting element from said selected orientation.

2. The suspension system of claim 1 wherein said connecting element is a molded part, said cylindrical portion having a surface which is free of mold-removal burrs.

3. The suspension system of claim 1 wherein said piston rod guide has a recess surrounding said bore, said retaining plate being fitted in said recess.

4. The suspension system of claim 3 wherein said piston rod guide is made of a material which can be deformed, said retaining plate being retained in said recess by deforming said material to overlap said retaining plate.

5. The suspension system of claim 4 wherein the recess has an external contour which is at least partially circular.

6. The suspension system of claim 5 wherein the retaining plate has an external contour which is at least partially circular.

7. The suspension system of claim 5 wherein said retaining plate comprises means for preventing rotation of said retaining plate in said recess.

8. The suspension system of claim 7 wherein said means for preventing rotation comprises a notch in the external contour of the retaining plate, said material of said piston rod guide being deformed to flow into said notch.

9. The suspension system of claim 1 further comprising a sealing ring fitted radially between said cylindrical sealing portion and said piston rod guide.

10. The suspension system of claim 9 further comprising a support ring fitted around the cylindrical sealing portion between the sealing ring and the lobe.

11. The suspension system of claim 10 wherein the support ring is free to move axially with respect to the connecting element.

12. The suspension system of claim 1 wherein the lobe is axially retained under the plate by rotating the connecting element through approximately ninety degrees from said selected orientation.

13. The suspension system of claim 1 wherein said connecting element has two lobes, said lobes being retained under said plate on opposite sides of said elongate aperture when said connecting element is rotated from said selected orientation.
